(19) United States
(12) Patent Application Publication
(10) Pub. No.: US 2008/0097880 A1
(43) Pub. Date: Apr. 24, 2008

(54) Remote Electronic Transactions

(76) Inventor: Brian Landberg, Tokyo (JP)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/587,724

(22) PCT Filed: Apr. 29, 2004
(86) PCT No.: PCT/IB04/01698

§ 371 Date: Aug. 2, 2007

(51) Int. Cl. G06Q 40/00; G06F 17/00

(52) U.S. Cl. 705/35

(57) ABSTRACT

Embodiments of the invention relate to a list of entries, each of which is associated with a potential electronic transaction such as a gift purchase. Each entry comprises a plurality of displayable fields including a first field which is selectable to access a remote location, such as a web-server, —for making an electronic transaction and a second field comprising price information concerning the electronic transaction.

### TECHNICAL FIELD

Embodiments of the invention relate to remote electronic transactions, and in particular improving the way in which a user manages potential remote electronic transaction.

### BACKGROUND OF THE INVENTION

At present certain electronic commerce web-sites provide facilities for recording a list of items a user intends to purchase. Typically such a web-site maintains a catalogue of items and the user selects an item for potential purchase by adding to a “shopping cart” or “shopping basket”. The web-site provides a web-page that lists the items selected for potential purchase. The user may view this list and change the quantities of the items in the shopping cart. When the user is satisfied with the itemized potential purchases, she “checks out” all the items that are in the shopping cart. This initiates an electronic transaction for purchasing the items listed in the shopping cart. Typically, the contents of the shopping basket are maintained until they are purchased even when the user exits the web-site. A user may therefore use the shopping basket to record future potential purchases.

A user may therefore store a record of future potential purchases at each one of a plurality of different web-sites.

This presents problems for a user, as the user must remember what was intended to be purchased and from where.

It would therefore be desirable to improve the way in which a user manages potential remote electronic transactions.

It would be desirable to consolidate a plurality of separate shopping basket lists into a centralized list and enable the selective purchase of an entry on the list.

### BRIEF SUMMARY OF THE INVENTION

According to one aspect of the present invention there is provided a graphical user interface for displaying potential future electronic transactions comprising:

a list of entries, each of which comprises a plurality of displayable fields including a first field which is selectable to access a remote location for making an electronic transaction and a second field comprising price information concerning the electronic transaction, the list comprising: a first entry associated with a first electronic transaction at a first remote location that comprises a plurality of displayable fields including: a first field which is user selectable to access the first remote location for making the first electronic transaction and a second field comprising price information concerning the first electronic transaction; and

a second entry associated with a second electronic transaction at a second remote location and comprising a plurality of displayable fields including: a first field which is user selectable to access the second remote location for making the second electronic transaction and a second field comprising price information concerning the second electronic transaction.

According to another embodiment of the present invention there is provided a data structure comprising: a list of entries, each of which comprises a plurality of displayable fields including a first field for accessing a remote location for making an electronic transaction and a second field comprising price information concerning the electronic transaction, the list comprising: a first entry associated with a first electronic transaction at a first remote location that comprises a plurality of displayable fields including: a first field for accessing the first remote location for making the first electronic transaction and a second field comprising price information concerning the first electronic transaction; and a second entry associated with a second electronic transaction at a second remote location and comprising a plurality of displayable fields including: a first field for accessing the second remote location for making the second electronic transaction and a second field comprising price information concerning the second electronic transaction.

According to another embodiment of the invention there is provided a browser application program for browsing web-pages stored at a remote web-server comprising: means for sending a request to a remote web-site for updating a first data structure that comprises: a list of entries, each of which comprises a plurality of displayable fields including a first field for accessing a web page for making an electronic transaction and a second field comprising price information concerning the electronic transaction; means for receiving, in reply to the request, a second data structure, comprising price information concerning an electronic transaction at the remote web-site; and means for creating an entry in the first data structure using the received second data structure and thereby enabling a future electronic transaction at the remote web-site using the first data structure.

According to another embodiment of the invention there is provided an electronic device for maintaining a first data structure for use in making electronic transactions comprising: a memory for storing a first data structure that comprises: a list of entries, each of which comprises a plurality of displayable fields including a first field for accessing a web page for making an electronic transaction and a second field comprising price information concerning the electronic transaction; a browser application for browsing web-pages stored at a remote web-server; a display for displaying a browsed web-page and for displaying the list of entries comprised in the first data structure; means for sending a request to a remote server for updating the first data structure;

means for receiving from the remote server in reply to the request a second data structure, including a field comprising price information concerning an electronic transaction at the remote web-site; and means for creating an entry in the first data structure using the received second data structure.

According to another aspect of the invention there is provided a web-server for facilitating the maintenance of a first data structure comprising: a list of entries, each of which comprises a plurality of displayable fields including a first field for accessing a web page for making an electronic transaction and a second field comprising price information concerning the electronic transaction, the web-server comprising: a memory for storing web pages; means for enabling a remote device to access a stored web-page; means for receiving a request for updating a first data structure from a remote device; means for processing the web-page accessed by the remote device to extract price information concerning an electronic transaction; and means for sending a reply to the request, including a second data structure, comprising the extracted price information, for updating the first data structure and thereby enabling a future electronic transaction via the first data structure.

According to another embodiment of the invention there is provided a method of maintaining in a computer readable memory a first data structure, which comprises: a list of entries, each of which comprises a plurality of displayable fields including a first field for accessing a web page for making an electronic transaction and a second field comprising price information concerning the electronic transaction, the method comprising: sending a request to a remote web-site for updating the first data structure; receiving in reply a second data structure, including a field comprising price information concerning an electronic transaction at the remote web-site; and creating a new entry in the first data structure stored in the computer readable medium using the second data structure.

According to another embodiment of the invention there is provided a graphical user interface for a web browser application comprising: a display portion for displaying the content of a web page; and a user selectable option for automatically updating a data structure using information from the displayed content of a web page.

According to another embodiment of the invention there is provided a method of facilitating the purchase of gifts comprising: publishing a personal list of potential gift purchases, comprising a plurality of entries, each of which comprises a plurality of displayable fields including a first field for accessing a web page for purchasing a gift, and a second field comprising price information for the gift; and remotely updating the list by adding entries to and removing entries from the personal list of potential gift purchase.

According to another embodiment of the invention there is provided a method of purchasing of gifts for a first person comprising: the first person publishing a list of potential gift purchases, comprising a plurality of entries, each of which comprises a plurality of displayable fields including a first field for accessing a web page for purchasing a gift, and a second field comprising price information for the gift; a second person accessing the published list, the second person using a first field of a first entry to access a first web page; and the second person using the first web page to purchase the first gift.

### BRIEF DESCRIPTION OF DRAWINGS

For a better understanding of the present invention reference will now be made by way of example only to the accompanying drawings in which:

FIG. 1 schematically illustrates an example of an electronic commerce (e-commerce) system 10;

FIG. 2 illustrates an example of a list 50 of potential purchases;

FIG. 3 illustrates a graphical user interface (GUI) of a browser application;

FIG. 4 is a signal diagram for signal exchange when the list 50 is updated; and

FIG. 5 illustrates an example of a data structure 115.

### DETAILED DESCRIPTION OF EMBODIMENT(S) OF THE INVENTION

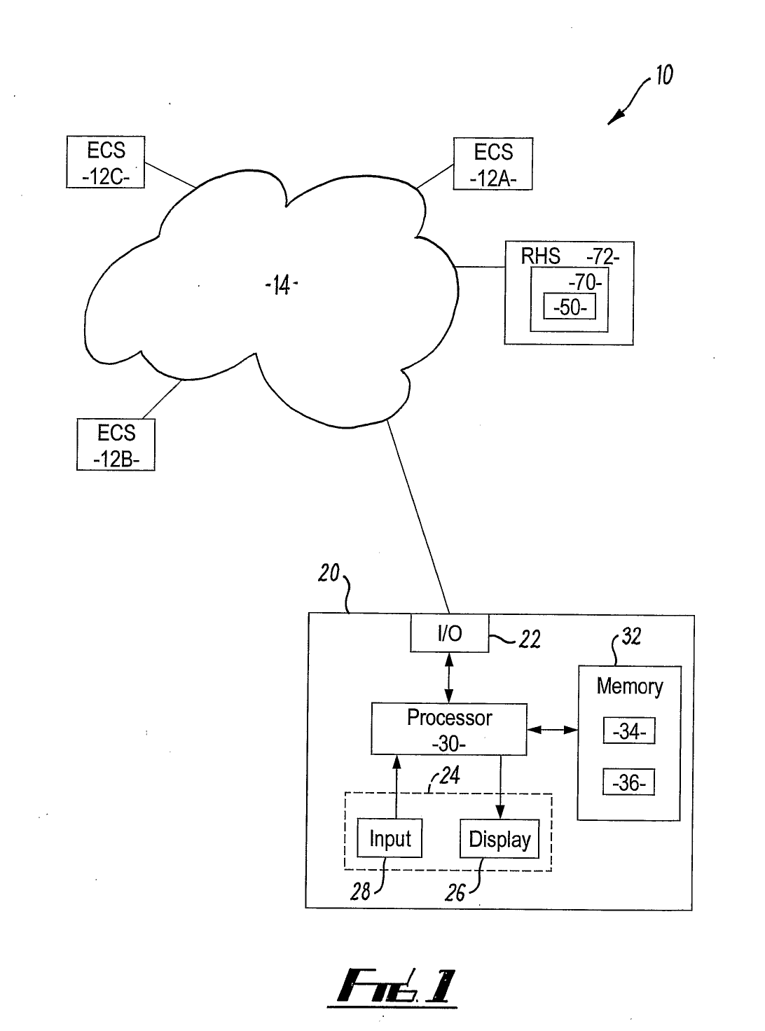

FIG. 1 schematically illustrates an electronic commerce (e-commerce) system 10 comprising at least one terminal 20, a plurality of e-commerce servers 12A, 12B, 12C that are remote from the terminal 20 and a network 14 for connecting the terminal 20 to any one of the e-commerce servers 12.

In this example, the terminal 20 comprises: a communications interface 22 for connection to the network 14; a user interface 24 including a display 26 and a user input device 28; a processor 30; and a memory 32. The processor 30 is connected to receive data from the network 14 via the communications interface 22 and to provide data to the network 14 via the communications interface 22. The processor 30 is also connected to write to and read from the memory 32 and to receive command signals from the user input device 28 and to provide command signals to the display 26.

The processor 30 controls the operation of the terminal 20 and is itself controlled by computer program instructions read from the memory 32. The memory 32, for example, stores browser application data 34, which when loaded into the processor 30 enables the terminal 20 to operate as a web browser using an appropriate mark-up language. The memory 32, for example, stores ‘wish-list’ application data 36, which when loaded into the processor 30 enables the terminal 20 to manage and display a ‘wish-list’ of potential purchases. The processor 30 may be able to concurrently provide the browser application and ‘wish-list’ application.

Although the preferred implementation of the terminal 20 has been described, it should be appreciated that multiple processors may be used instead of a single processor, or alternatively, the processor 30 could be replaced by dedicated or programmable integrated circuits.

The terminal 20 is typically a computer or a hand-portable electronic device such as a personal digital assistant (pda) or a cellular mobile telephone. Typically the network 14 comprises the Internet and the e-commerce servers 12 are web-servers that support one or more Extensible Markup Language (XML) or Hypertext Markup Language (HTML) web-sites each of which allows a user to browse through a plurality of web-pages and to make on-line purchases.

When the terminal 20 is a mobile cellular telephone the network 14 includes a cellular mobile telephone network but may also include the Internet. The communications interface 22 is, in this example, a radio cellular transceiver. The e-commerce servers 12 may be located within the mobile telephone network or the Internet. The e-commerce severs 12 may also be optimized for mobile commerce (m-commerce). Such an optimized server 12 may support one or more Wireless Markup Language (WML) or imode web-sites each of which allows a user to browse through a plurality of simplified web-pages and to make on-line purchases via their mobile cellular telephone.

The ‘wish-list’ application organizes and displays a list 50 of potential purchases.

This list 50 reminds a user of what she wants to purchase and from/where she wants to purchase and provides easy electronic access to make the purchase via the network 14.

The ‘wish-list’ application maintains the list 50 that centralizes the storage of information identifying potential purchases that are purchasable from different servers 12 and centralizes the storage of information for accessing the different servers 12 to make those potential purchases.

The list 50 comprises a sequential list of a plurality of displayable entries 59. Each entry 59 is associated with a potential purchase from a remote location and comprises an address 53 for accessing the remote location and at least price information 55 for the potential purchase. Typically the remote location is a web-site and the address is a URI of a page at the web-site that is displayed as a selectable hyperlink.

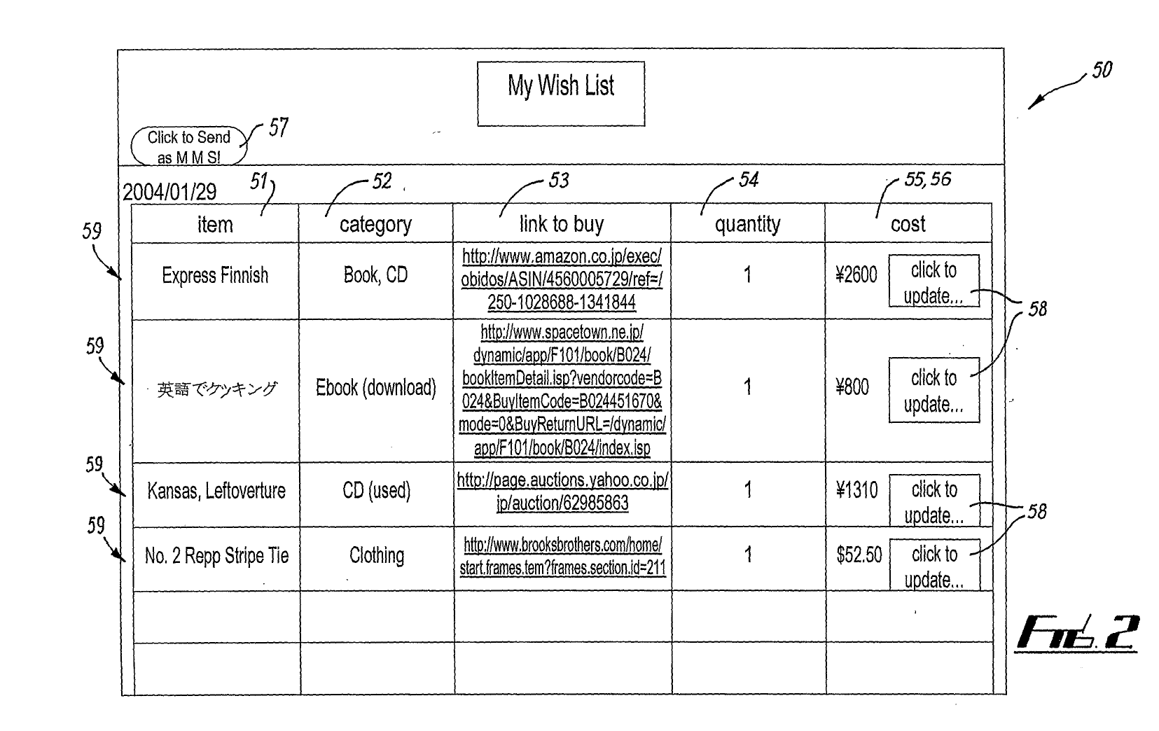

FIG. 2 illustrates an example of a list 50 when displayed on the display 26. The list 50 is party of a graphical user interface to the ‘wish-list’ application that allows potential purchases to be made.

The list 50 in this example is arranged as an N row×M column array of data entry fields, where each row corresponds to an entry 59. Each entry 59 relates to a single potential purchase of an item or items from a particular remote web-site.

In this example each entry 59 may have 5 fields (i.e. M=5) including: a name 51 of the item for purchase; a description 52 of the item for purchase; a hyperlink 53 to the website to purchase the item; a quantity 54 for purchase; and Price information 55 and Currency type information 56.

For each entry 59, the fields 51-56 are filled with data obtained from the web-site selling the potential purchase associated with that entry 59 as explained below. Each entry 59 may have one or more additional fields that are completed manually by the user. For example, there may be a column of fields that indicate, for each potential purchase, for whom the purchase is for. This option may be used to indicate whether a potential purchase is a gift for someone else or a suitable gift for the user herself.

Other information that may be required for a purchase such as shipping address information, gift-wrapping option, etc. are generally stored or input when making a purchase at the point of sale i.e. the e-commerce web-site. Alternatively, however, the wish-list application may store the shipping address of the user and enable this to be provided via the browser application when an item is purchased via the list 50.

If the terminal 20 is a mobile cellular telephone, the user may be able to send the list 50 to another terminal as a multimedia messaging service (MMS) message by selecting the user selectable option 57 (if present).

The list 50 may be stored as a single data structure 60 such as a database. This data structure 60 may be stored in the memory 32 of the terminal 20 as part of the ‘wish-list’ application data 36 or as a logically separate entity to the ‘wish-list’ application data 36 in the memory 32. An advantage of storing the list 50 in the terminal 20 is that the list 50 is available for viewing even when the terminal 20 is disconnected from the network 14.

Alternatively or in addition, and as illustrated in FIG. 1, the data structure 60 may be stored in a memory 70 of a remote host server 72. An advantage of this is that the list 50 is available for viewing by third parties or by means other than the terminal 20. Thus friends of the user could access the remotely stored list 50 to purchase a gift for the terminal user. In this case, it is appropriate to have additional fields in the list 50. One such field would be a privacy field and another would be a gift field. The privacy field if selected for an entry would prevent that entry appearing when a third party viewed the list 50. The gift field if selected would indicate that an item is a suitable gift purchase for the terminal user.

Alternatively instead of two fields a single gift field could be provided, which, if selected, would indicate that an item is a suitable gift purchase for the terminal user and if not selected for an entry would prevent that entry appearing when a third party viewed the list 50.

The list 50 may be personalized. The user may, via the ‘wish-list’ application, and using the user input device 28 manually add, remove or edit an entry in the list 50. The list 50 may also be updated via the browser application. For example, an entry may be added to the list 50 and entries in list 50 may be automatically removed.

As a simple example, a user may copy information from an e-commerce web-page using the browser application and paste it into the list 50 displayed by the ‘wish-list’ application. It may be necessary to copy that data for each field of the new entry separately. Manual text entry may also be used to complete fields.

As another example, the browser application may include a function that controls the updating of the list 50 and allows the auto-copying of data from a web-page into the relevant fields of an entry in the list 50.

The auto-copying of data may be fully automatic, where the copying occurs automatically without the user taking a dedicated positive action to initiate it, or semi-automatic, where the copying occurs automatically only after the user takes a dedicated positive action to initiate it such as selecting a user selectable ‘update wish list’ option in the browser application.

An illustrative example of a graphical user interface (GUI) of a suitable browser application is illustrated in FIG. 3. The GUI 100 comprises a toolbar portion and a display portion 104. The toolbar portion 102 comprises an address bar 110 displaying the URI of the web-page currently displayed in the display portion 104. The toolbar portion also comprises a plurality of user selectable options, which in this example are represented by separate user selectable widgets (buttons 112). One of these buttons 112′ provides the user selectable ‘update wish list’ option in the browser application.

As an illustrative example, a user may semi-automatically save data to the list 50 by:

a) accessing a website by, for example, entering its URI in the address bar 110 of the browser GUI 100;

b) selecting, from the display portion 104 of the GUI 100, a hyperlink to a desired item for purchase;

c) adding the item to the website's proprietary shopping basket, for example, by selecting an appropriate icon in the display portion 104 of the GUI 100;

d) viewing the web-site's proprietary shopping basket without making a purchase; and

e) selecting the “update wish-list” option 112′ in the toolbar portion 102 of the GUI 100.

Typically, the shopping basket has a plurality of entries, one entry for each potential purchase.

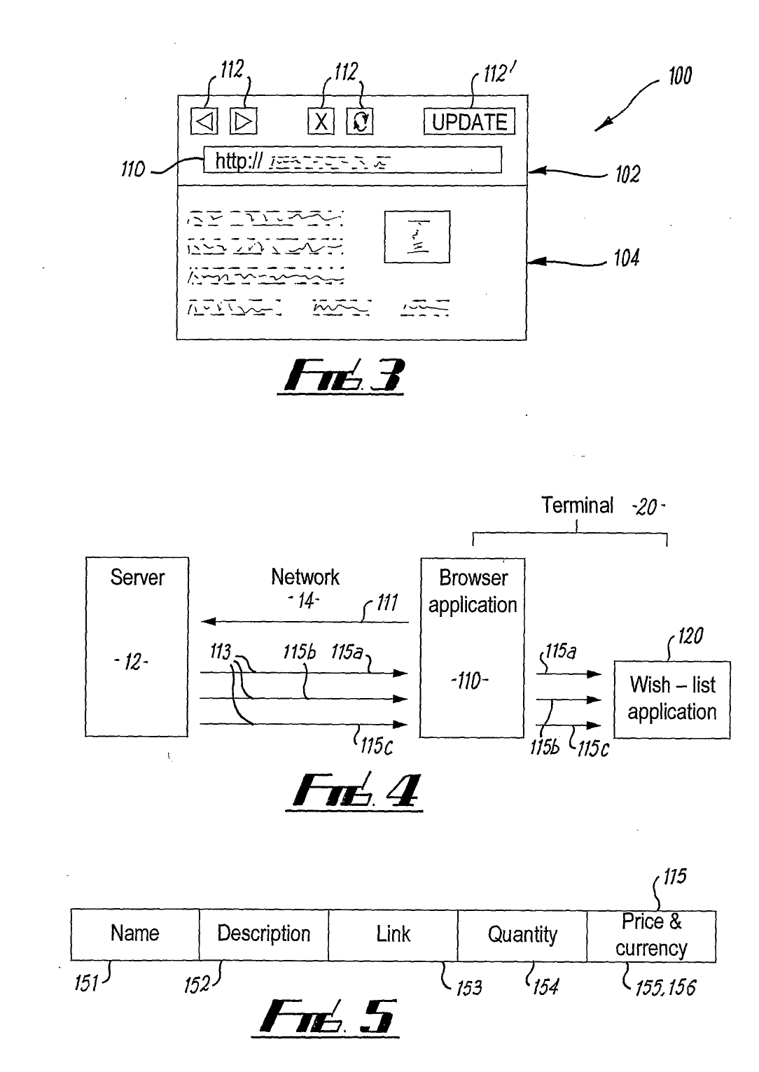

As illustrated in FIG. 4, in response to selecting the “update wish-list” option 112′, the browser application 110 sends a request 111 to the remote server 12 hosting the current web-page.

The server 12 interprets the request 111 and sends a reply 113 in a predetermined format. The reply 113 includes a data structure 115 for each one of the entries in the proprietary shopping basket. Each data structure 115 comprises at least price information for the potential purchase corresponding to that entry.

For example each data structure 115 may comprise, as illustrated in FIG. 5, a plurality of fields including: a name 151 of the item for purchase; a description 152 of the item for purchase; a hyperlink 153 to the website to purchase the item; a quantity 154 for purchase; and price information 155 and currency type information 156.

The data structure 115 has a predetermined, standardized format such as Extensible Markup Language (XML), Hypertext Markup Language (HTML), Wireless markup language (WML) or comma separated values (CSV).

An example of a reply 113 from a web-site that has two entries in its proprietary shopping basket includes first and second data structures 115a and 115b.

The data structure 115a is in CSV format and reads:

“Express Finnish”, “Book”, www.amazon.com/shoppingbasket/user#123456789/contents.htm, “1”, “14.95”, “USD”

The data structure 115b is in CSV format and reads:

“Math for Dummies”, “Book”, www.amazon.com/shoppingbasket/user#123456789/contents.htm, “1”, “14.95”, “USD”

The browser application 110 transfers the received data structures 115a, 115b to the wish-list application 120. The wish-list application 120 automatically makes a new entry in the list 50 for each data structure received. The fields 51-56 of the new entry 59 in the list 50 are taken from the respective fields 151-156 of the received respective data structure 115. Thus a new entry 59 is created in the list 50 for each entry in the proprietary shopping basket and the information in the list 50 for that entry originates from the shopping basket.

The data structure 114 may not include a field 153 for the hyperlink to the web-site. In this case the value for the field 53 is taken from the content of address bar 110 of the GUI 100 of the browser application 110.

In the example above, the web-site had a proprietary shopping basket. If the web-site does not have a proprietary shopping basket, then the user may semi-automatically saves data to the list 50 by:

a) accessing a website by, for example, entering its URI in the address bar 110 of the browser GUI 100;

b) selecting, from the display portion 104 of the GUI 100, a hyperlink to a desired item for purchase; and

c) selecting the “update wish-list” option 112′ in the toolbar portion 102 of the GUI 100.

As an illustrative example, a user may fully-automatically save data to the list 50 by:

a) accessing a website by, for example, entering its URI in the address bar 110 of the browser GUI 100;

b) selecting, from the display portion 104 of the GUI 100, a hyperlink to a desired item for purchase;

c) adding the item to the website's proprietary shopping basket, for example, by selecting an appropriate icon in the display portion 104 of the GUI 100;

d) viewing the web-site's proprietary shopping basket without making a purchase; and

e) exiting the shopping basket.

Exiting the shopping basket is detected by the browser application 110, which in response sends a request 111 to the server 12. Thus exiting the shopping basket in the fully automatic browser application is equivalent to electing the “update wish-list” option 112′ in the semi-automatic browser application. Thus a semi-automatic browser application requires a selectable ‘update wish-list’ option 112′ whereas the fully-automatic browser application does not.

To prevent multiple similar entries in the list 50, the wish-list application 120 intelligently removes existing entries from the list that correspond to new entries to the list 50. The wish-list application 120, when it receives new entries for the list 50 from a particular URI, deletes the existing entries in the list 50 associated with that URI via the field 53.

A user may consequently obtain a price update on a particular entry by selecting the link in the field 53 for that entry. The user then selects the “update wish-list” option 112′ and the entries in the list 50 for that shopping basket are replaced with updated versions. This two stage process may be combined as a macro that is activated when a user selects the ‘update’ option 58 in the list 50.

It will therefore be appreciated that a user can move from e-commerce site to e-commerce site and augment the list 50 at each site.

If at a later time, a person wishes to make a purchase from the list 50, they access the list 50 and select the link in field 53 for the desired purchase. The browser application 110 then automatically opens at the web-page for purchasing that item. The user then purchases the item by completing a transaction with the remote server 12.

The person can then return to the shopping basket and select the “update wish-list” option, which will update the list 50 and remove the purchased item from the list. Alternatively, the user may manually edit the list 50 to remove the item.

Although embodiments of the present invention have been described in the preceding paragraphs with reference to various examples, it should be appreciated that modifications to the examples given can be made without departing from the scope of the invention as claimed.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. A program stored on a computer readable medium for providing a graphical user interface for displaying potential future electronic transactions, said graphical user interface comprising:
a list of entries, each of which comprises a plurality of displayable fields including a first field which is selectable to access a remote location for making an electronic transaction and a second field comprising price information concerning the electronic transaction, the list comprising:
a first entry associated with a first electronic transaction at a first remote location that comprises a plurality of displayable fields including:
a first field which is user selectable to access the first remote location for making the first electronic transaction and a second field comprising price information concerning the first electronic transaction; and
a second entry associated with a second electronic transaction at a second remote location and comprising a plurality of displayable fields including:
a first field which is user selectable to access the second remote location for making the second electronic transaction and a second field comprising price information concerning the second electronic transaction.

2. A program for providing a graphical user interface as claimed in claim 1, wherein the first electronic transaction and second electronic transaction involves respective first and second purchases.

3. A program for providing a graphical user interface as claimed in claim 1, wherein each of the entries has only a single user selectable field—for accessing a remote location to make an electronic transaction.

4. A program for providing a graphical user interface as claimed in claim 1, wherein each of the entries is associated with a different electronic transaction.

5. A program for providing a graphical user interface as claimed in claim 1, wherein each of the entries is associated with a single remote location.

6. A program for providing a graphical user interface as claimed in claim 1, wherein a plurality of different entries have a same first field.

7. A program for providing a graphical user interface as claimed in claim 1, wherein the plurality of displayable fields for an entry includes a field for text information identifying the electronic transaction associated with that entry.

8. A program for providing a graphical user interface as claimed in claim 1, wherein the plurality of displayable fields for an entry includes a field for identifying a quantity relating to the electronic transaction associated with that entry.

9. A program for providing a graphical user interface as claimed in claim 1, wherein the first field of the first entry is selectable to initiate a partial update of the list of entries including updating at least the first entry, but not the second entry.

10. A program for providing a graphical user interface as claimed in claim 1, wherein the first field of the first entry is selectable to initiate a partial update of the list of entries including updating all the entries having the same first field as the selected first field.

11. A program for providing a graphical user interface as claimed in claim 9, wherein the updating of an entry involves its deletion or replacement.

12. A program for providing a graphical user interface as claimed in claim 1, wherein one or more of the entries comprises a gift field that enables a user to indicate whether the associated electronic transaction is suitable as a gift purchase.

13. A program for providing a graphical user interface as claimed in claim 1, wherein one or more of the entries comprises a privacy field that enables a user to restrict publication of an entry.

14. A program for providing a graphical user interface as claimed in claim 1, wherein the first field of the first entry comprises a first URI for a first web-site and the first field of the second entry comprises a second URI for a second web-site.

15. A program for providing a graphical user interface as claimed in claim 1, wherein the first field of the first entry is a first user-selectable hyperlink and the first field of the second entry is a second user-selectable hyperlink.

16. A program for providing a graphical user interface as claimed in claim 1, comprising a device for transmitting the list of entries.

17. A program for providing a graphical user interface as claimed in any preceding claim comprising a user-selectable device for updating the second field of an entry.

18. An electronic device for generating a graphical user interface as claimed in claim 1.

19. A data structure—embodied in a computer readable medium comprising: a list of entries, each of which comprises a plurality of displayable fields including a first field for accessing a remote location for making an electronic transaction and a second field comprising price information concerning the electronic transaction, the list comprising:
a first entry associated with a first electronic transaction at a first remote location that comprises a plurality of displayable fields including:
a first field for accessing the first remote location for making the first electronic transaction and a second field comprising price information concerning the first electronic transaction; and
a second entry associated with a second electronic transaction at a second remote location and comprising a plurality of displayable fields including:
a first field for accessing the second remote location for making the second electronic transaction and a second field comprising price information concerning the second electronic transaction.

20. A data structure as claimed in claim 19, wherein said computer readable medium comprises a memory in a server and a memory in a mobile terminal of a communications system.

21. A data structure as claimed in claim 19, wherein said computer readable medium comprises a memory of a remotely accessible server.

22. A data structure as claimed in claim 19, wherein said data structure is embodied in a memory of a mobile terminal.

23. A browser application-program embodied in a computer readable medium for browsing web-pages stored at a remote web-server comprising:
a sending element for sending a request to a remote web-site for updating a first data structure that comprises: a list of entries, each of which comprises a plurality of displayable fields including a first field for accessing a web page for making an electronic transaction and a second field comprising price information concerning the electronic transaction;
a receiving element for receiving, in reply to the request, a second data structure, comprising price information concerning an electronic transaction at the remote web-site; and
a creating element for creating an entry in the first data structure using the received second data structure and thereby enabling a future electronic transaction at the remote web-site using the first data structure.

24. A browser application as claimed in claim 23, —further comprising a user-selectable widget for initiating the sending of a request.

25. An electronic device for operating a browser application program as claimed in claim 23.

26. An electronic device—for maintaining a first data structure for use in making electronic transactions comprising:
a memory for storing a first data structure that comprises: a list of entries, each of which comprises a plurality of displayable fields including a first field for accessing a web page for making an electronic transaction and a second field comprising price information concerning the electronic transaction;
a browser application for browsing web-pages stored at a remote web-server;
a display for displaying a browsed web-page and for displaying the list of entries comprised in the first data structure;
a sending element for sending a request to a remote server for updating the first data structure;
a receiving element for receiving from the remote server in reply to the request a second data structure, including a field comprising price information concerning an electronic transaction at the remote web-site; and
a creating element for creating an entry in the first data structure using the received second data structure.

27. An electronic device as claimed in claim 26, wherein the second data structure additionally comprises a URI of a web-page.

28. An electronic device as claimed in claim 26, wherein the creating element for creating an entry in the first data structure uses the received data structure and a URI of a currently displayed web-page.

29. An electronic device as claimed in claim 26, wherein the—browser application comprises a graphical use interface having a user-selectable widget for initiating the sending of the request.

30. A web-server for facilitating the maintenance of a first data structure comprising: a list of entries, each of which comprises a plurality of displayable fields including a first field for accessing a web page for making an electronic transaction and a second field comprising price information concerning the electronic transaction, the web-server comprising:
a memory for storing web pages;
an enabling element for enabling a remote device to access a stored web-page;
a receiving element for receiving a request for updating a first data structure from a remote device;
a processing element for processing the web-page accessed by the remote device to extract price information concerning an electronic transaction; and
a sending element for sending a reply to the request, including a second data structure, —comprising the extracted price information, for updating the first data structure and thereby enabling a future electronic transaction via the first data structure.

31. A method of maintaining in a computer readable memory a first data structure, which comprises: a list of entries, each of which comprises a plurality of displayable fields including a first field for accessing a web page for making—an electronic transaction and a second field comprising price information concerning the electronic transaction, the method comprising:
sending a request to a remote web-site for updating the first data structure;
receiving in reply a second data structure, —including a field comprising—price information concerning an electronic transaction at the remote web-site; —and
creating a new entry in the first data structure stored in the computer readable medium using the second data structure.

32. A method as claimed in claim 31, further comprising making an electronic transaction after accessing a web page of the remote web-site using the first field of the new entry.

33. A graphical user interface for a web browser application stored on a computer readable medium comprising:
a display portion for displaying the content of a web page; and
a user selectable portion for providing an option for automatically updating a data structure using information from the displayed content of a web page.

34. A graphical user interface as claimed in claim 33, wherein the data structure comprises: a list of entries, each of which comprises a plurality of displayable fields including a first field for accessing a web page for making—an electronic transaction and a second field comprising price information concerning the electronic transaction and wherein user selection of the user selectable option updates those entries of the list having the same first field.

35. A graphical user interface as claimed in claim 33, wherein the user selectable option removes or replaces those entries of the list having the same first field.

36. An electronic device for generating a graphical user interface as claimed in claim 33.

37. A method of facilitating the purchase of gifts over a communications network, said method comprising:
publishing a personal list of potential gift purchases in a way that is accessible over the communications network, said list comprising a plurality of entries, each of which comprises a plurality of displayable fields including a first field for accessing a web page for purchasing a gift, and a second field comprising price information for the gift; and
remotely updating the list over the communications network by adding entries to and removing entries from the personal list of potential gift purchases.

38. A method of purchasing of gifts for a first person over a communications network, said method comprising:
the first person publishing a list of potential gift purchases in a way that is accessible over said communications network, said list comprising a plurality of entries, each of which comprises a plurality of displayable fields including a first field for accessing a web page for purchasing a gift, and a second field comprising price information for the gift;
a second person accessing the published list,
the second person using a first field of a first entry to access a first web page; and
the second person using the first web page to purchase the first gift.

39. (canceled)

40. (canceled)
